(19) United States
(12) Patent Application Publication
(10) Pub. No.: US 2012/0270092 A1
(43) Pub. Date: Oct. 25, 2012

(54) LITHIUM ION SECONDARY BATTERY AND BATTERY PACK SYSTEM

(75) Inventors: Hidetoshi Honbou, Hitachinaka (JP); Masayoshi Kanno, Iwaki (JP); Masanori Yoshikawa, Hitachinaka (JP)

(73) Assignee: HITACHI, LTD.

(21) Appl. No.: 13/445,952

(22) Filed: Apr. 13, 2012

(30) Foreign Application Priority Data
Apr. 22, 2011 (JP) 2011-095567

(51) Int. Cl. H01M 10/052

(52) U.S. Cl. 429/156; 429/188; 429/200

(57) ABSTRACT

An object is to provide a high-capacity lithium ion secondary battery enhanced in safety against overcharging by adding an overcharge retardant additive, which is highly responsive to excessive voltage application, to a nonaqueous electrolytic solution.

A lithium ion secondary battery comprising:
a separator,
positive and negative electrodes arranged with the separator interposed therebetween and reversibly storing/releasing lithium ions, and
an organic electrolytic solution having an electrolyte containing the lithium ions dissolved therein,
wherein the organic electrolytic solution contains an aromatic compound represented by a general formula (1) below:

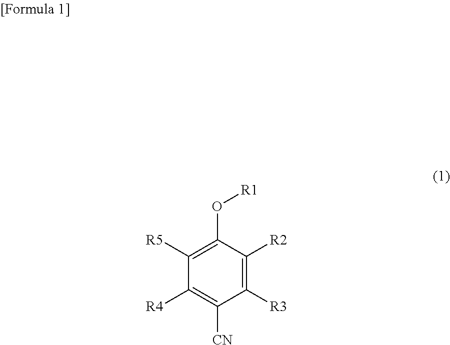

where R1 represents an alkyl group and R2 to R5 each independently represent any one of hydrogen, a halogen group, an alkyl group, an aryl group, an alkoxy group and a tertiary amine group; and
a concentration of the aromatic compound is 0.1 mol/L or less.

### TECHNICAL FIELD

The present invention relates to a lithium ion secondary battery, and more particularly, relates to a high-capacity lithium ion secondary battery for use in electric cars and electric storage systems.

### BACKGROUND ART

A technique for ensuring safety against overcharging is disclosed in Patent Literatures 1 to 3. More specifically, Patent Literatures 1 to 3 disclose a technique of suppressing overcharging of a battery by an approach, in which a solution having an overcharge retardant additive such as cyclohexylbenzene, biphenyl, 3-R-thiophene, 3-chlorothiophene or furan dissolved in an electrolytic solution is used to generate a gas within a battery in an overcharging condition, thereby driving an internal electro disconnection device or by an approach in which a conductive polymer is produced within a battery in an overcharging condition.

### CITATION LIST

### Patent Literature

[Patent Literature 1] Japanese Patent No. 3275998
[Patent Literature 2] JP 9-171840 A
[Patent Literature 3] JP 10-321258 A

### TECHNICAL PROBLEM

A lithium ion secondary battery containing a nonaqueous electrolytic solution is characterized by high voltage (operating voltage: 4.2 V) and high energy density. Because of the characteristics, the lithium ion secondary battery has been widely used in the field of portable digital devices, etc., and the demand for the lithium ion secondary battery has been rapidly increasing. At present, the lithium ion secondary battery has already established a position as a standard cell for mobile digital devices including mobile phones and notebook computers.

A lithium ion secondary battery is constituted of components: a positive electrode, a negative electrode and a nonaqueous electrolytic solution. Particularly, a lithium secondary battery generally used employs a lithium complex metal oxide represented by LiMO₂ (M contains at least one of metal element selected from Co, Ni, and Mn) as a positive electrode, a carbon material or an intermetallic compound containing Si, Sn, etc., as a negative electrode, and a nonaqueous solution having an electrolyte salt dissolved in a non-aqueous solvent (organic solvent) as an electrolytic solution.

As the non-aqueous solvent, a carbonate such as ethylene carbonate (EC), propylene carbonate (PC), dimethyl carbonate (DMC) and diethyl carbonate (DEC) is generally used.

In such a lithium ion secondary battery, in an overcharging condition where a voltage beyond a general operation voltage (for example, 4.2V at the time of full charge in the case of LiCoO₂) is applied, excessive lithium ions are released from a positive electrode; at the same time, excessive lithium ions deposit at the negative electrode to produce dendrite. Because of the presence of dendrite, both positive and negative electrodes become chemically unstable. Dendrite eventually reacts with a carbonate in the nonaqueous electrolytic solution and decomposes, leading to an abrupt exothermic reaction. Consequently, abnormal heat generation of the entire battery takes place, impairing the safety of battery. This is a problem.

Generally, a protective circuit or the like is provided to prevent overcharging, thereby preventing internal short circuit. Because of the presence of such a countermeasure, a battery may not lead to the abnormal state. However, it is supposed that a battery charger or a protective circuit may break. Therefore, a battery itself needs to be safe even in an overcharging condition.

In the high-capacity lithium ion secondary battery used in electric cars and electric storage systems, since charging/discharging is performed at a high-current, input/output of electric energy increases. Therefore, a more excellent countermeasure for safety is required against overcharging. To describe more specifically, an overcharge retardant additive, which is used by dissolving it in a nonaqueous electrolytic solution, is required to have a chemical property, that is, when excessive voltage is applied to a battery, the overcharge retardant additive immediately causes a chemical reaction to avoid an unstable state that may be caused by the abnormal charging. The response of a conventional overcharge retardant additive to excessive voltage application is too poor to sufficiently avoid the unstable state caused by abnormal charging. Thus, in a conventional lithium ion secondary battery, when excessive voltage is applied to the battery, heat is abnormally generated from the entire battery. Likewise, safety of the battery is a matter of concern.

The present invention is directed to providing a high-capacity lithium ion secondary battery enhanced in safety against overcharging by adding an overcharge retardant additive, which is highly responsive to excessive voltage application, to a nonaqueous electrolytic solution (organic electrolytic solution).

### SUMMARY OF INVENTION

The lithium ion secondary battery according to the present invention comprises: a separator, positive and negative electrodes arranged with the separator interposed therebetween and reversibly storing/releasing lithium ions, and an organic electrolytic solution having an electrolyte containing the lithium ions dissolved therein, wherein the organic electrolytic solution contains an aromatic compound represented by a general formula (1) below:

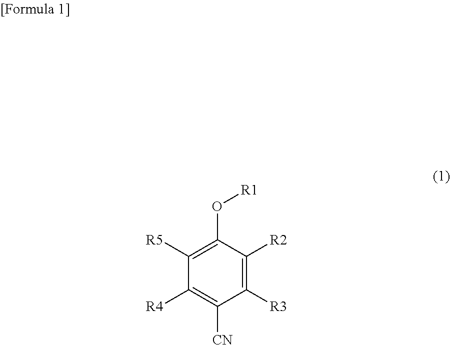

where R1 represents an alkyl group and R2 to R5 each independently represent any one of hydrogen, a halogen group, an alkyl group, an aryl group, an alkoxy group and a tertiary amine group, and R2 to R5 may be all the same or at least one of R2 to R5 may differ; and a concentration of the aromatic compound is 0.1 mol/L or less.

It should be further understood by those skilled in the art that although the foregoing description has been made on embodiments of the invention, the invention is not limited thereto and various changes and modifications may be made without departing from the spirit of the invention and the scope of the appended claims.

### ADVANTAGEOUS EFFECTS OF INVENTION

Owing to the present invention, it is possible to provide a high-capacity lithium ion secondary battery excellent in safety even if abnormal voltage is applied, leading to an overcharging condition.

### BRIEF DESCRIPTION OF DRAWINGS

FIG. 1 shows a fragmentary sectional view of the lithium ion secondary battery according to an embodiment of the present invention;

FIG. 2 is a graph showing the results of cyclic voltammogram measurements of an additive-free electrolytic solution;

FIG. 3 is a graph showing the results of cyclic voltammogram measurements of an electrolytic solution containing 4-methoxybenzonitrile as an additive; and

FIG. 4 is a graph showing the results of cyclic voltammogram measurements of an electrolytic solution containing cyclohexylbenzene as an additive.

### DESCRIPTION OF EMBODIMENTS

The present inventors found that an unstable state in an overcharging condition can be avoided by incorporating an aromatic compound having an alkoxy group in combination with a nitrile group as an overcharge retardant additive to an organic electrolytic solution (nonaqueous electrolytic solution) because the aromatic compound immediately causes a decomposition reaction when abnormally high voltage is applied and has excellent potential response. Now, the lithium ion secondary battery according to the present invention will be more specifically described below. Note that, hereinafter, an overcharge retardant additive will be simply referred to as an “additive” and an organic electrolytic solution (nonaqueous electrolytic solution) will be simply referred to as an “electrolytic solution”.

The lithium ion secondary battery according to the present invention has a positive electrode and a negative electrode reversibly storing/releasing lithium ions and an organic electrolytic solution (nonaqueous electrolytic solution) having an electrolyte containing lithium ions dissolved therein. The positive electrode and the negative electrode are arranged with a separator interposed therebetween them an aromatic compound represented by the general formula (1) below is contained as an additive in the organic electrolytic solution (nonaqueous electrolytic solution).

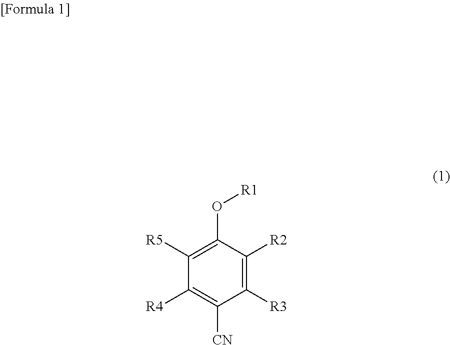

In the general formula (1), R1 represents an alkyl group; R2 to R5 each independently represent any one of hydrogen, a halogen group, an alkyl group, an aryl group, an alkoxy group and a tertiary amine group; and R2 to R5 may be all the same or at least one of R2 to R5 may differ.

Examples of such an aromatic compound include 4-methoxybenzonitrile, 4-phenoxybenzonitrile, 3,5-dimethyl-4-methoxybenzonitrile, 2,4,6-trimethoxybenzonitrile, 3,4,5-trimethoxybenzonitrile, 3-fluoro-4-methoxybenzonitrile, 3-bromo-4-methoxybenzonitrile, 3-chloro-4-methoxybenzonitrile, 4-(trifluoromethoxy)-benzonitrile, 2,4-dimethoxy-6-methylbenzonitrile, 4-methoxy-2,5-dimethyl benzonitrile, 3-tertiarybutyl-4-methoxybenzonitrile, 2-amino-4,5-dimethoxybenzonitrile and 1,3-benzo dioxolol-5-carbonitrile. The aromatic compounds mentioned above may be contained singly or in combination in an organic electrolytic solution.

These aromatic compounds are oxidatively decomposed at an oxidation potential within the range of 4.3V or more and 5.5 V or less on a lithium metal basis. At this time, decomposition current flows. The initial rise of potential response thereof is excellent. Because of this, when abnormally high voltage is applied, these aromatic compounds are rapidly decomposed to avoid an unstable state due to overcharging of the lithium ion secondary battery. Particularly, the oxidation potential desirably falls within the range of 4.4 V or more and 5.0 V or less on a lithium metal basis. This is because a side reaction does not occur in the usual operation range and an oxidation reaction starts immediately upon onset of overcharging.

The nitrile group of the general formula (1) is an electron attractive group, which attracts electrons from an aromatic ring, is effective in enhancing oxidation potential; conversely, an electron donating group, which transfers electrons to the aromatic ring, is effective in lowering oxidation potential. To attain an oxidation potential within the range of 4.4 V or more and 5.0 V or less on a lithium metal basis, an electron attractive group and an electron donating group may be used in an appropriate combination and at least one of R2 and R5 of the general formula (1) is desirably an electron donating group. Examples of the electron donating group include an alkoxy group and a tertiary amine group.

As the electron donating group particularly effective for suppressing overcharging, 3,4-dimethoxybenzonitrile represented by the general formula (2) below is mentioned.

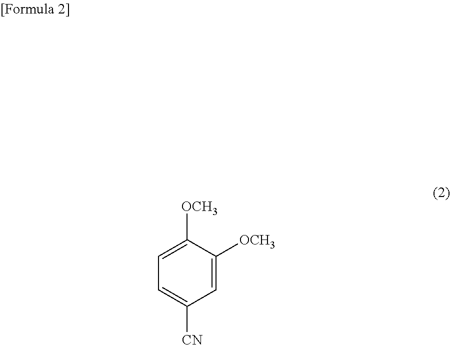

Note that, the aromatic compound to be employed in the present invention is slightly reductively decomposed at a negative electrode and may increase negative-electrode resistance. Thus, the addition amount of aromatic compound needs to be set within a proper range. If the concentration of an aromatic compound added is 0.1 mol/L (mol/Liter) or less, sufficient overcharge retardation effect is produced; at the same time, reductive decomposition at the negative electrode can be suppressed. This is experimentally demonstrated. If the concentration of an aromatic compound added is 0.05 mol/L (mol/Liter) or more, the initial direct-current resistance can be reduced.

Furthermore, as another means for suppressing slight reductive decomposition of an aromatic compound to be used in the present invention at a negative electrode, it is effective to separately add an organic compound having a C═C unsaturated bond within the molecule as an additive to an electrolytic solution. Examples of a compound having such an unsaturated bond that can be used include vinylene carbonate, vinylethylene carbonate, allylethyl carbonate, diallyl carbonate, vinyl acetate, 2,5-dihydrofuran, furan-2,5-dione and methyl cyanate. The addition amount of these additives preferably falls within the range of 0.5 to 5 wt %.

Furthermore, as a means for suppressing an effect of resistance increase at a negative electrode by reductive decomposition of the aromatic compound to be used in the present invention, a graphite material, which has a graphite interlayer space (d₀₀₂) within the range of 0.337 nm to 0.338 nm and a specific surface area (measured by the BET method using nitrogen gas) of 2 m²/g or less, may be used in a negative electrode.

The surface of a graphite material has an edge plane, which stores lithium ions, and a basal plane along a hexagonal-net plane. In the graphite material, high orientation is observed along the hexagonal net plane. Generally, the percentage of a basal plane in the surface of a graphite material is high. If an storing/release reaction (charging/discharging reaction) of lithium ions is performed by use of a graphite material, a specific irreversible reaction occurs, by which an electrolytic solution is decomposed to form a passivation film on the graphite surface, in the initial cycle. When the edge plane is compared to the basal plane, it is considered that an irreversible reaction dose in the edge plane through which lithium ions come in and out is larger. Since the irreversible reaction, if occurs at a negative electrode formed of a graphite material, may cause a reduction in battery capacity, a material having as a small irreversible capacity as possible has been chosen as a material for a negative electrode, up to present. However, if such a material is used, there is a possibility that the percentage of the edge plane extremely reduces. Conversely, it is considered that input/output of lithium ions is suppressed and resistance of a charging/discharging reaction increases.

Then, the present inventors studied negative electrode materials suitable for the aromatic compound to be used in the present invention. As a result, they found that when the aforementioned graphite material is used, an excellent negative electrode coating property can be obtained with a low specific surface area. In addition, they found that the edge-plane ratio can be increased and an increase in resistance of a negative electrode can be suppressed.

Furthermore, separately from the aromatic compound to be used in the present invention, a conventional aromatic compound, which is polymerized by electrolysis at an oxidation potential within the range of 4.3 V or more and 5.5 V or less on a lithium metal basis, can be added as an additive. Examples of such a conventional aromatic compound include benzene, toluene, xylene, ethylbenzene, cumene, tertiary butylbenzene, cyclohexylbenzene, biphenyl and naphthalene. The amount of these additives preferably falls within the range of 0.5 to 5 wt %.

As a positive-electrode active material of the lithium ion secondary battery according to the present invention, a complex compound between lithium and a transition metal is used, which has e.g., a crystal structure such as a spinel type cubical crystal, a layer-type hexagonal crystal, an olivine type orthorhombic crystal or a triclinic crystal. In view of high power, high energy density and long life, a layer-type hexagonal crystal at least containing lithium, nickel, manganese and cobalt is preferred. Particularly, a complex compound of a layer-type hexagonal crystal represented by the general formula Li₁₊ₐNi_{b}Mn_{c}Co_{d}N′ₑO₂ is preferred. Note that, N′ represents an element added to a positive-electrode material of a layer-type hexagonal crystal system. When an element of which binding force to oxygen is strong is added to a positive electrode material as an additive element, the crystal structure of the positive electrode is stabilized and lithium ions are easily input or output in a charging/discharging reaction. As a result, high-capacity lithium ion secondary battery can be obtained. Examples of such an additive element N′ include Al, Mg, Mo, Ti, Ge and W. N′ may include at least one of Al, Mg, Mo, Ti, Ge and W. It is particularly preferable that a material represented by a general formula of Li₁₊ₐNi_{b}Mn_{c}Co_{d}N′ₑO₂ where 0.05≦a≦0.1, 0.33≦b≦0.6, 0.2≦c≦0.33, 0.1≦d≦0.33, and 0≦e≦0.1 is used as a positive electrode in attaining a lithium ion secondary battery having a high energy density.

In the lithium ion secondary battery according to the present invention, an unstable state due to overcharging can be avoided immediately upon onset of overcharging, and thus can be used in, for example, load conditioners, medical equipment, cars, electric cars, golf carts, electric carts and power storage systems. Particularly, when a plurality of batteries according to the present invention are used to form a battery pack system, a highly reliable electric-source system can be obtained for the equipment and apparatuses exemplified above.

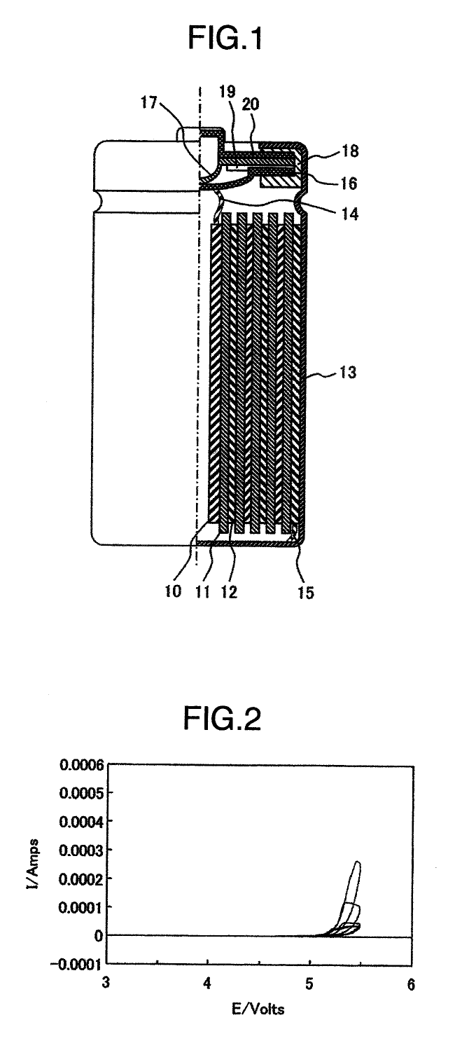

FIG. 1 shows a fragmentary sectional view of the lithium ion secondary battery according to an embodiment of the present invention. In FIG. 1, a cylindrical secondary battery of a nonaqueous electrolytic solution system is shown. The lithium ion secondary battery has a positive electrode 10, a separator 11, a negative electrode 12, a battery can 13, a positive electrode collector tab 14, a negative electrode collector tab 15, an inner cover 16, an inner-pressure releasing valve 17, a gasket 18, PTC device 19 and an outside cover 20. The positive electrode 10, separator 11 and negative electrode 12 are impregnated with a nonaqueous electrolytic solution.

### <Electrolytic Solution>

As the organic solvent to be used in an electrolytic solution, a mixture of a solvent having a high dielectric constant and a solvent having a low-viscosity is used.

As the solvent having a high dielectric constant, an ester containing a carbonate is more preferable. Of them, use of an ester having a dielectric constant of 30 or more is recommended. Examples thereof include ethylene carbonate, propylene carbonate, butylene carbonate, γ-butyrolactone and a sulfur ester group (ethylene glycol sulfite, etc.). Of these, a cyclic ester is preferable, and a cyclic carbonate such as ethylene carbonate, vinylene carbonate, propylene carbonate and butylene carbonate is particularly preferable.

Examples of the solvent having a low viscosity that can be used include a linear carbonate such as dimethyl carbonate, diethyl carbonate and methylethyl carbonate and a branched aliphatic carbonate compound. Furthermore, other than the non-aqueous solvent, an organic solvent including a linear alkyl ester such as methyl propionate, a linear triester of phosphoric acid such as trimethyl phosphate, a nitrile solvent such as 3-methoxypropionitrile, and a branched compound having an ether bond represented by a dendrimer and dendron; and a fluorine-base solvent can be used.

Examples of the fluorine-base solvent include a linear (perfluoroalkyl)alkyl ether such as H(CF₂)₂OCH₃, C₄F₉OCH₃, H(CF₂)₂OCH₂CH₃, H(CF₂)₂OCH₂CF₃, H(CF₂)₂CH₂O(CF₂)₂H, CF₃CHFCF₂OCH₃ and CF₃CHFCF₂OCH₂CH₃. Alternatively, iso (perfluoroalkyl)alkyl ether, more specifically 2-trifluoromethyl hexafluoropropyl methyl ether, 2-trifluoromethyl hexafluoropropyl ethyl ether, 2-trifluoromethyl hexafluoropropyl propyl ether, 3-trifluorooctafluorobutyl methyl ether, 3-trifluorooctafluorobutyl ethyl ether, 3-trifluorooctafluorobutyl propyl ether, 4-trifluorodecafluoropentyl methyl ether, 4-trifluorodecafluoropentyl ethyl ether, 4-trifluorodecafluoropentyl propyl ether, 5-trifluorododecafluorohexyl methyl ether, 5-trifluorododecafluorohexyl ethyl ether, 5-trifluorododecafluorohexyl propyl ether, 6-trifluorotetradecafluoroheptyl methyl ether, 6-trifluorotetradecafluoroheptyl ethyl ether, 6-trifluorotetradecafluoroheptyl propyl ether, 7-trifluorohexadecafluorooctyl methyl ether, 7-trifluorohexadecafluorooctyl ethyl ether, 7-trifluorohexadecafluorohexyl octyl ether and the like may be mentioned.

As the electrolyte salt, a lithium salt such as a perchloric acid salt of lithium, a lithium organoboron salt, a lithium salt of a fluorine-containing compound and an imide salt of lithium are preferred. Examples thereof include LiClO₄, LiPF₆, LiBF₄, LiCF₃SO₃, LiCF₃CO₂, Li₂C₂F₄ (SO₃)₂, LiN(CF₃SO₂)₂, LiN(C₂F₅SO₂)₂, LiC(CF₃SO₂)₃, LiCₙF₂ₙ₊₁SO₃ (n≧2) and LiN(RfOSO₂)₂ (where Rf is a fluoro alkyl group). Of these lithium salts, a lithium organofluorine salt is particularly preferable. The concentration of an electrolyte salt is 0.3 mol/L (mol/Liter) or more, and more preferably 0.7 mol/L or more; and preferably 1.7 mol/L or less and more preferably 1.2 mol/L or less. If the electrolyte salt concentration is excessively low, ionic conductivity is sometimes low. In contrast, if the electrolyte salt concentration is excessively high, an electrolyte salt that remains undissolved may precipitate.

Ten types of electrolytic solutions prepared will be shown below. Electrolytic solution 1 does not contain an additive; whereas electrolytic solutions 2 to 10 contain an additive.

### <Preparation of Electrolytic Solution 1>

Ethylene carbonate (EC), dimethyl carbonate (DMC) and ethylmethyl carbonate (EMC) were mixed in a volume ratio of 1:1:1 and then LiPF₆ was dissolved in a concentration of 1 mol/L to prepare a basic electrolytic solution.

### <Preparation of Electrolytic Solution 2>

Ethylene carbonate (EC), dimethyl carbonate (DMC) and ethylmethyl carbonate (EMC) were mixed in a volume ratio of 1:1:1 and then LiPF₆ was dissolved in a concentration of 1 mol/L to prepare a basic electrolytic solution. To the basic electrolytic solution, 4-methoxybenzonitrile (0.1 mol/L) was added.

### <Preparation of Electrolytic Solution 3>

Ethylene carbonate (EC), dimethyl carbonate (DMC) and ethylmethyl carbonate (EMC) were mixed in a volume ratio of 1:1:1 and then LiPF₆ was dissolved in a concentration of 1 mol/L to prepare a basic electrolytic solution. To the basic electrolytic solution, cyclohexylbenzene (0.1 mol/L) was added. Electrolytic solution 3 is the same electrolytic solution in the art using cyclohexylbenzene as an additive.

### <Preparation of Electrolytic Solution 4>

Ethylene carbonate (EC), dimethyl carbonate (DMC) and ethylmethyl carbonate (EMC) were mixed in a volume ratio of 1:1:1 and then LiPF₆ was dissolved in a concentration of 1 mol/L to prepare a basic electrolytic solution. To the basic electrolytic solution, 3,5-dimethyl-4-methoxybenzonitrile (0.1 mol/L) was added.

### <Preparation of Electrolytic Solution 5>

Ethylene carbonate (EC), dimethyl carbonate (DMC) and ethylmethyl carbonate (EMC) were mixed in a volume ratio of 1:1:1 and then LiPF₆ was dissolved in a concentration of 1 mol/L to prepare a basic electrolytic solution. To the basic electrolytic solution, 3-fluoro-4-methoxybenzonitrile (0.08 mol/L) was added.

### <Preparation of Electrolytic Solution 6>

Ethylene carbonate (EC), dimethyl carbonate (DMC) and ethylmethyl carbonate (EMC) were mixed in a volume ratio of 1:1:1 and then LiPF₆ was dissolved in a concentration of 1 mol/L to prepare a basic electrolytic solution. To the basic electrolytic solution, 2-amino-4,5-dimethoxybenzonitrile (0.05 mol/L) was added.

### <Preparation of Electrolytic Solution 7>

Ethylene carbonate (EC), dimethyl carbonate (DMC) and ethylmethyl carbonate (EMC) were mixed in a volume ratio of 1:1:1 and then LiPF₆ was dissolved in a concentration of 1 mol/L to prepare a basic electrolytic solution. To the basic electrolytic solution, 3,4-dimethoxybenzonitrile (0.1 mol/L) was added.

### <Preparation of Electrolytic Solution 8>

Ethylene carbonate (EC), dimethyl carbonate (DMC) and ethylmethyl carbonate (EMC) were mixed in a volume ratio of 1:1:1 and then LiPF₆ was dissolved in a concentration of 1 mol/L to prepare a basic electrolytic solution. To the basic electrolytic solution, 3,4-dimethoxybenzonitrile (0.1 mol/L) and vinylene carbonate (2 wt %) were added.

### <Preparation of Electrolytic Solution 9>

Ethylene carbonate (EC), dimethyl carbonate (DMC) and ethylmethyl carbonate (EMC) were mixed in a volume ratio of 1:1:1 and then LiPF₆ was dissolved in a concentration of 1 mol/L to prepare a basic electrolytic solution. To the basic electrolytic solution, 3,4-dimethoxybenzonitrile (0.1 mol/L) and cyclohexylbenzene (5 wt %) were added.

### <Preparation of Electrolytic Solution 10>

Ethylene carbonate (EC), dimethyl carbonate (DMC) and ethylmethyl carbonate (EMC) were mixed in a volume ratio of 1:1:1 and then LiPF₆ was dissolved in a concentration of 1 mol/L to prepare a basic electrolytic solution. To the basic electrolytic solution, 3,4-dimethoxy benzonitrile (0.2 mol/L) was added.

### <Measurement by Cyclic Voltammogram>

Electrolytic solutions 1 to 3 were subjected to measurement by cyclic voltammogram (CV) performed at room temperature to check oxidation decomposition behavior of each electrolytic solution. Platinum was used as the operation electrode and a lithium metal was used as the reference electrode and the counter electrode. Electrolytic solution 1 does not contain an additive. Electrolytic solution 2 contains 0.1 mol/L 4-methoxybenzonitrile as an additive. Electrolytic solution 3 contains 0.1 mol/L cyclohexylbenzene as an additive and equivalent to a conventional electrolytic solution.

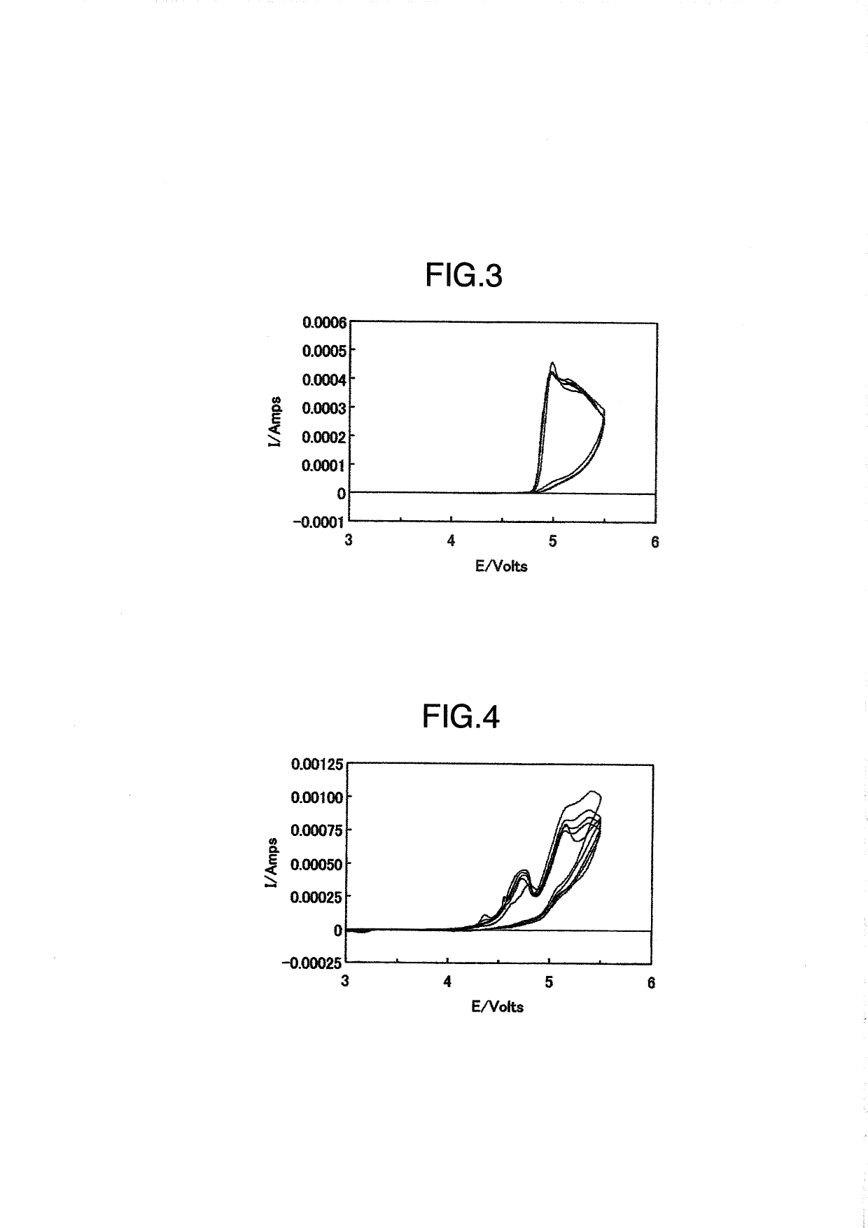

FIG. 2 to FIG. 4 each are a graph showing the results of CV measurement. In the graphs, the horizontal axis indicates application voltage and the vertical axis indicates current response. FIG. 2 shows the case where electrolytic solution 1 (additive-free electrolytic solution) was used; FIG. 3 shows the case where electrolytic solution 2 (electrolytic solution containing 4-methoxybenzonitrile as an additive) was used; and FIG. 4 shows the case where electrolytic solution 3 (electrolytic solution containing cyclohexylbenzene as an additive) was used.

In the CV measurement results in the case of using electrolytic solution 1 (containing no additive), as shown in FIG. 2, a decomposition current is low in an overcharging region of 4.5V or more. In the CV measurement results in the case of using electrolytic solutions 2 and 3 (containing an additive), as shown in FIG. 3 and FIG. 4, it is found that decomposition current flows in the overcharging region due to oxidation of additives.

Particularly, in the case of electrolytic solution 2 containing an aromatic nitrile compound, shown in FIG. 3, compared to the case of electrolytic solution 3 containing cyclohexylbenzene (a case of conventional electrolytic solution), shown in FIG. 4, a sharp initial rise of decomposition current is observed. From the results, it is found that electrolytic solution 2 shows excellent potential response as seen in the initial rise of decomposition current. This means that response to excessive-voltage application is excellent. In addition, in the case of electrolytic solution 2, as shown in FIG. 3, when an applied voltage exceeds a predetermined voltage (5V), an increase of current is suppressed. Likewise, intrinsic electrochemical behavior was observed.

Furthermore, even in the cases where electrolytic solutions 4 to 10 containing an aromatic nitrile compound were used, according to the CV measurement results, a sharp initial rise of decomposition current and the behavior that an increase of current is suppressed at an applied voltage beyond a predetermined voltage (5V), were observed, similarly to the case where electrolytic solution 2 was used.

In short, when an aromatic nitrile compound represented by the general formula (1) is added to an electrolytic solution, if abnormally high voltage is applied to a battery, current is consumed by oxidation decomposition in the beginning, immediately diffusing accumulated energy. In this manner, an unstable condition is avoided. Furthermore, if an applied voltage exceeds a predetermined voltage, battery resistance extremely increases, effectively terminating current supply.

### <Negative Electrode>

### <Preparation of Negative Electrode 1>

As a negative electrode active material, a high crystalline graphite powder having a graphite interlayer space (d₀₀₂) of 0.3356 nm and an average particle size of 10 μm was used. To this, polyvinylidene fluoride (PVDF) was mixed at a weight ratio of 90:10 and an appropriate amount of N-methyl-2-pyrrolidone was added to prepare slurry. This slurry was sufficiently kneaded by stirring it by a planetary mixer for one hour. Subsequently, the kneaded slurry was applied to a copper foil having a thickness of 10 μm by use of a coating machine of a roll-transfer system. The slurry was applied to both surfaces of the copper foil to prepare a negative electrode sheet, which was dried at 120° C. Thereafter, the sheet was pressed by a roll press at a linear pressure of 100 kgf/cm. At this time, the density of the negative electrode composite was 1.5 g/cm³.

A half cell of negative electrode 1 and a lithium metal as a counter electrode was prepared by using electrolytic solution 1. The irreversible capacity in the first lithium storing/releasing reaction (charging/discharging reaction) was checked. As a result, the irreversible capacity was 32 mAh/g in terms of weight of a graphite carbon material in the negative electrode.

### <Preparation of Negative Electrode 2>

Coal pitch was subjected to a partial oxidation crosslinking treatment performed in the air, at 500° C. and then the temperature thereof was raised to 800° C. in an inert atmosphere to obtain coke. This was crushed by a hummer mill and a pulverizer mill to have an average particle size of 15 μm. The coke fine powder previously pulverized was used as a raw material and a heat treatment was performed in a graphitization furnace at 2800° C. to obtain a graphite material having a graphite interlayer space (d₀₀₂) of 0.338 nm and a specific surface area (measured by the BET method using nitrogen gas) of 2 m²/g. To this, polyvinylidene fluoride (PVDF) was added so as to obtain a weight ratio of 90:10 and an appropriate amount of N-methyl-2-pyrrolidone was added to prepare slurry. This slurry was sufficiently kneaded by stirring it by a planetary mixer for one hour. Subsequently, the kneaded slurry was applied to a copper foil having a thickness of 10 μm by use of a coating machine of a roll-transfer system. The slurry was applied to both surfaces of the copper foil to prepare a negative electrode sheet, which was dried at 120° C. Thereafter, the sheet was pressed by a roll press at a linear pressure 100 kgf/cm. At this time, the density of the negative electrode composite was 1.5 g/cm³.

A half cell of negative electrode 2 was prepared by using electrolytic solution 1 and a lithium metal as a counter electrode. The irreversible capacity in the first lithium storing/releasing reaction (charging/discharging reaction) was checked. As a result, the irreversible capacity was 51 mAh/g in terms of weight of a graphite carbon material in the negative electrode.

### <Preparation of Negative Electrode 3>

Coal pitch was subjected to a partial oxidation crosslinking treatment performed in the air, at 500° C. and then the temperature thereof was raised to 800° C. in an inert atmosphere to obtain coke. This was crushed by a hummer mill and a pulverizer mill to obtain coke fine powder particles having an average size of 20 μm. The coke fine powder previously pulverized was used as a raw material and a heat treatment was performed in a graphitization furnace at 2800° C. to obtain a graphite material having a graphite interlayer space (d₀₀₂) of 0.337 nm and a specific surface area (measured by the BET method using nitrogen gas) of 1.5 m²/g. To this, polyvinylidene fluoride (PVDF) was added so as to obtain a weight ratio of 90:10 and an appropriate amount of N-methyl-2-pyrrolidone was added to prepare slurry. This slurry was sufficiently kneaded by stirring it by a planetary mixer for one hour. Subsequently, the kneaded slurry was applied to a copper foil having a thickness of 10 μm by use of a coating machine of a roll-transfer system. The slurry was applied to both surfaces of the copper foil to prepare a negative electrode sheet, which was dried at 120° C. Thereafter, the sheet was pressed by a roll press at a linear pressure 100 kgf/cm. At this time, the density of the negative electrode composite was 1.5 g/cm³.

A half cell of negative electrode 3 was prepared by using electrolytic solution 1 and a lithium metal as a counter electrode. The irreversible capacity in the first lithium storing/releasing reaction (charging/discharging reaction) was checked. As a result, the irreversible capacity was 45 mAh/g in terms of weight of a graphite carbon material in the negative electrode.

### <Positive Electrode>

### <Preparation of Positive Electrode 1>

Nickel oxide, manganese oxide and cobalt oxide, which were used as raw materials, were weighed so as to obtain an atomic ratio of Ni:Mn:Co of 1:1:1, pulverized and mixed by a wet crusher to obtain a crushed powder mixture. Subsequently, to this, polyvinyl alcohol (PVA) was added as a binder. The resultant crushed powder mixture was granulated by a spray dryer. The resultant granulated powder was placed in a container formed of highly purified alumina. To evaporate PVA, preliminary baking was performed at 600° C. for 12 hours, cooled in the air and cracked to obtain a cracked powder. Furthermore, to the cracked powder, lithium oxide monohydrate was added so as to obtain an atomic ratio of Li:transition metals (a total of Ni, Mn and Co) of 1.1:1, and sufficiently mixed to obtain a powder mixture. The powder mixture was placed in a container formed of highly purified alumina and subjected to a main baking process performed at 900° C. for 6 hours. The resultant positive-electrode active material was cracked and classified. The positive-electrode active material thus prepared, which is represented by a composition formula of Li_{1.1}Ni_{0.33}Mn_{0.33}Co_{0.33}O₂, had an average particle size of 6 p.m.

Next, the positive-electrode active material, a conductive material and polyvinylidene fluoride (PVDF) were mixed and an appropriate amount of N-methyl-2-pyrrolidone was added to prepare slurry. As the conductive material, powdery graphite, scale-like graphite and amorphous carbon were used. The positive-electrode active material, powdery graphite, scale-like graphite, amorphous carbon and PVDF were mixed so as to obtain a weight ratio of 85:7:2:2:4. The slurry thus prepared was sufficiently kneaded by stirring it by a planetary mixer for 3 hours. Subsequently, the kneaded slurry was applied to an aluminum foil having a thickness of 20 μm by use of a coating machine of a roll-transfer system. The slurry was applied to both surfaces of the aluminum foil to prepare a positive electrode sheet, which was dried at 120° C. Thereafter, the sheet was pressed by a roll press at a linear pressure of 250 kgf/cm. At this time, the density of the positive electrode composite was 2.8 g/cm³.

### <Preparation of Positive Electrode 2>

Nickel oxide, manganese oxide, cobalt oxide and titanium oxide, which were used as raw materials, were weighed so as to obtain an atomic ratio of Ni:Mn:Co:Ti of 6:2:1:1, pulverized and mixed by a wet crusher to obtain a crushed powder mixture. Subsequently, to this, polyvinyl alcohol (PVA) was added as a binder. The resultant crushed powder mixture was granulated by a spray dryer. The resultant granulated powder was placed in a container formed of highly purified alumina. To evaporate PVA, preliminary baking was performed at 600° C. for 12 hours, cooled in the air and cracked to obtain cracked powder. Furthermore, to the cracked powder, lithium oxide monohydrate was added so as to obtain an atomic ratio of Li:transition metals (a total of Ni, Mn, Co and Ti) of 1.05:1, and sufficiently mixed to obtain a powder mixture. The powder mixture was placed in a container formed of highly purified alumina and subjected to a main baking process performed at 900° C. for 6 hours. The resultant positive-electrode active material was cracked and classified. The positive-electrode active material thus prepared, which is represented by a composition formula of Li_{1.05}Ni_{0.6}Mn_{0.2}Co_{0.1}Ti_{0.1}O₂, had an average particle size of 6 μm.

Next, the positive-electrode active material, a conductive material and polyvinylidene fluoride (PVDF) were mixed and an appropriate amount of N-methyl-2-pyrrolidone was added to prepare slurry. As the conductive material, powdery graphite, scale-like graphite and amorphous carbon were used. The positive-electrode active material, powdery graphite, scale-like graphite, amorphous carbon and PVDF were mixed so as to obtain a weight ratio of 85:7:2:2:4. The slurry thus prepared was sufficiently kneaded by stirring it by a planetary mixer for 3 hours. Subsequently, the kneaded slurry was applied to an aluminum foil having a thickness of 20 μm by use of a coating machine of a roll-transfer system. The slurry was applied to both surfaces of the aluminum foil to prepare a positive electrode sheet, which was dried at 120° C. Thereafter, the sheet was pressed by roll press at a linear pressure 250 kgf/cm. At this time, the density of the positive electrode composite was 2.8 g/cm³.

### Preparation of Cylindrical Battery

### Example 1

The sheet of a positive electrode 1 and the sheet of a negative electrode 1 each were cut into pieces of a predetermined size. To an uncoated portion of both ends of each electrode, a collector tab was attached by ultrasonic welding. The positive-electrode collector tab was formed of aluminum; whereas the negative-electrode collector tab was formed of nickel. Between the positive electrode and the negative electrode, a porous polyethylene film serving as a separator was sandwiched. The positive electrode, negative electrode and separator were rolled up into a cylindrical form. The rolled-up cylinder was inserted in a battery can and the negative-electrode collector tab was welded to the battery can, whereas the positive-electrode collector tab was welded to the inner cover of the battery. Furthermore, electrolytic solution 4 was poured in the battery can and a battery cover was provided to the battery can to prepare a lithium ion secondary battery according to Example 1 of the present invention.

### Example 2

A lithium ion secondary battery according to Example 2 of the present invention was prepared in the same manner as in Example 1 except that electrolytic solution 5 was used as the electrolytic solution.

### Example 3

A lithium ion secondary battery according to Example 3 of the present invention was prepared in the same manner as in Example 1 except that electrolytic solution 6 was used as the electrolytic solution.

### Example 4

A lithium ion secondary battery according to Example 4 of the present invention was prepared in the same manner as in Example 1 except that electrolytic solution 7 was used as the electrolytic solution.

### Example 5

A lithium ion secondary battery according to Example 5 of the present invention was prepared in the same manner as in Example 1 except that electrolytic solution 8 was used as the electrolytic solution.

### Example 6

A lithium ion secondary battery according to Example 6 of the present invention was prepared in the same manner as in Example 1 except that electrolytic solution 9 was used as the electrolytic solution.

### Comparative Example 1

A lithium ion secondary battery according to Comparative Example 1 was prepared in the same manner as in Example 1 except that electrolytic solution 1 was used as the electrolytic solution.

### Comparative Example 2

A lithium ion secondary battery according to Comparative Example 2 was prepared in the same manner as in Example 1 except that electrolytic solution 10 was used as the electrolytic solution.

### Characteristics of Batteries According to Examples 1 to 6 and Comparative Examples 1 and 2

In the lithium ion secondary batteries according to Examples 1 to 6 and Comparative Examples 1 and 2, a designed rated capacity at 1 hour-rate (1 C) discharge is 8.5 Ah. The lithium ion secondary batteries according to Examples 1 to 6 and Comparative Examples 1 and 2 were subjected to measurement of initial charging/discharging capacity, which was performed at room temperature and a current of 1.7 A (=0.2 CA) corresponding to a 0.2 hour rate (0.2 C). Furthermore, the batteries were allowed to discharged was performed for 10 seconds in the order of current 4 CA, 8 CA, 12 CA and 16 CA. At this time, the discharge current and voltage at the 10th second were plotted to obtain a relationship between them. From the slope of the linear line thus obtained, the initial direct-current resistance was obtained. Furthermore, charging/discharging was repeatedly performed at a current of 1 CA to check a cycle life.

Table 1 shows the measurement results of characteristics of these batteries. To check an accurate charging/discharging capacity, the charging/discharging current was measured at a current of 0.2 CA lower than a rated current of 1 CA.

In the lithium ion secondary batteries according to Examples 1 to 6, initial charging/discharging capacities were about 9.0 Ah, which were all equal to or large than a designed rated capacity. Furthermore, initial direct-current resistances thereof were as small as 4.0 to 4.2 mΩ. Capacity retention rates after 500 cycles were as high as 82 to 88%. From this, the batteries have a long life.

In contrast, in the battery of Comparative Example 2 (battery using electrolytic solution 10), the amount of additive was as large as 0.2 mol/L. It is considered that reductive decomposition occurred at the negative electrode. Because of this, the initial capacity was as low as 8.1 Ah and the initial direct-current resistance was extremely large (8.2 mΩ). The capacity retention rate after 500 cycles was also as low as 52%.

From the results, it was demonstrated that, in the batteries of Examples 1 to 6, a side reaction at a negative electrode is suppressed by setting the amount of additive (aromatic nitrile compound) to 0.1 mol/L or less, and the initial charging/discharging capacity and the initial direct-current resistance corresponding to those of the additive-free battery of Comparative Example 1 (battery using electrolytic solution 1) were obtained. Furthermore, as is in the battery of Example 5 (battery using electrolytic solution 8), it is desirable to add vinylene carbonate having a C═C unsaturated bond to an electrolytic solution, since especially cycle deterioration is reduced.

TABLE 1

| | Initial | Initial direct- | Capacity |
|---|---|---|---|
| | charging/ | current | retention |
| | discharging | resistance | rate after 500 |
| Battery | capacity (Ah) | (mΩ) | cycles (%) |
| Example 1 | 9.0 | 4.0 | 85 |
| Example 2 | 9.0 | 4.0 | 85 |
| Example 3 | 8.9 | 4.2 | 84 |
| Example 4 | 9.0 | 4.0 | 85 |
| Example 5 | 8.9 | 4.0 | 88 |
| Example 6 | 8.9 | 4.2 | 82 |
| Comparative Example 1 | 9.0 | 4.0 | 85 |
| Comparative Example 2 | 8.1 | 8.2 | 52 |

### Overcharging Test of Batteries of Examples 1 to 6 and Comparative Examples 1 and 2

The lithium ion secondary batteries of Examples 1 to 6 and Comparative Examples 1 and 2 were each charged to full (4.2 V) and placed in a box formed of a thermosetting phenol resin board. An overcharging test was performed in the conditions: room temperature, a current of 1 CA, and an upper-limit voltage of 10V. In the overcharging test, whether a battery takes fire or not and the maximum surface temperature of a battery were checked.

Table 2 shows the results of the overcharging test. An additive-free battery of Comparative Example 1 (battery using electrolytic solution 1) took fire; whereas, the batteries of Examples 1 to 6 and Comparative Example 2 (batteries using electrolytic solution 4 to 10) did not take fire since an aromatic nitrile additive represented by the general formula (1) was contained. Furthermore, as is in the batteries of Examples 4 to 6 (batteries using electrolytic solutions 7 to 9), use of 3,4-dimethoxybenzonitrile as an additive is more desirable, since the maximum surface temperature of the battery reduces. Particularly, as is in the battery of Example 6 (battery using electrolytic solution 9), addition of an aromatic compound (cyclohexylbenzene) as used in a conventional electrolytic solution to an electrolytic solution is found to be more desirable since the maximum surface temperature of a battery significantly reduces.

Note that, the aromatic compound added to an electrolytic solution to reduce a maximum surface temperature of a battery is not limited to cyclohexylbenzene. An aromatic compound polymerized by electrolysis at an oxidation potential within the range of 4.3 V or more and 5.5 V or less, on a lithium metal basis, can be used.

TABLE 2

| | | Maximum surface temperature |
|---|---|---|
| Battery | Firing or not | of battery (° C.) |
| Example 1 | No firing | 110 |
| Example 2 | No firing | 110 |
| Example 3 | No firing | 110 |
| Example 4 | No firing | 105 |
| Example 5 | No firing | 105 |
| Example 6 | No firing | 102 |
| Comparative Example 1 | Firing | Not measured because |
| | | of firing |
| Comparative Example 2 | No firing | 110 |

As described above, from the results shown in Table 1 and Table 2, it is demonstrated that a lithium ion secondary battery having a good response, and having not only excellent battery characteristics but also high safety can be realized by adding an aromatic nitrile additive represented by the general formula (1) in an amount within a predetermined range (0.1 mol/L or less) to an electrolytic solution.

### Example 7

The sheet of the positive electrode 1 and the sheet of the negative electrode 2 were each cut into pieces of a predetermined size. To an uncoated portion of both ends of each electrode, a collector tab was attached by ultrasonic welding. The positive-electrode collector tab was formed of aluminum; whereas the negative-electrode collector tab was formed of nickel. Between the positive electrode and the negative electrode, a porous polyethylene film serving as a separator was sandwiched. The positive electrode, negative electrode and separator were rolled up into a cylindrical form. The rolled-up cylinder was inserted in a battery can and the negative-electrode collector tab was welded to the battery can, whereas the positive-electrode collector tab was welded to the inner cover of the battery. Furthermore, electrolytic solution 8 was poured in the battery can and a battery cover was provided to the battery can to prepare a lithium ion secondary battery according to Example 7 of the present invention.

### Example 8

A lithium ion secondary battery according to Example 8 of the present invention was prepared in the same manner as in Example 7 except that negative electrode 3 was used as the negative electrode.

### Example 9

A lithium ion secondary battery according to Example 9 of the present invention was prepared in the same manner as in Example 7 except that positive electrode 2 was used as the positive electrode.

### Characteristics of Batteries of Examples 7 to 9

In the lithium ion secondary batteries according to Examples 7 and 8, a designed rated capacity at 1 hour rate (1 C) discharge is 8.5 Ah. In the lithium ion secondary batteries according to Example 9, a designed rated capacity at 1 hour rate (1 C) discharge is 9.5 Ah. The lithium ion secondary batteries according to Examples 7 to 9 were checked for initial charging/discharging capacity, initial direct-current resistance, and cycle life at current values corresponding to respective hour rates, in the same manner as in Examples 1 to 6.

Table 3 shows measurement results of these battery characteristics.

TABLE 3

| | Initial | Initial direct- | Capacity retention |
|---|---|---|---|
| | charging/discharging | current resistance | rate after |
| Battery | capacity (Ah) | (mΩ) | 500 cycles (%) |
| Example 7 | 9.0 | 3.6 | 89 |
| Example 8 | 9.0 | 3.6 | 90 |
| Example 9 | 10.4 | 3.6 | 89 |

### Overcharging Test of Batteries of Examples 7 to 9

The lithium ion secondary batteries of Examples 7 to 9 were subjected to an overcharging test performed at the current value corresponding to a designed rated capacity, in the same manner as in Examples 1 to 6.

Table 4 shows the results of the overcharging test.

TABLE 4

| | | Maximum surface temperature of |
|---|---|---|
| Battery | Firing or not | battery (° C.) |
| Example 7 | No firing | 104 |
| Example 8 | No firing | 104 |
| Example 9 | No firing | 111 |

From the results shown in Table 3 and Table 4, in the batteries of Examples 7 to 9, it can be presumed that the percentage of an edge plane of a negative electrode is high. From this, it is found that battery resistance decreases and a long life can be attained. Furthermore, in the battery of Example 9 having a large storing/releasing amount of lithium of a positive electrode, it is found that, even if a high-capacity battery, it is highly safe since no firing takes place in an overcharging condition.

Note that, to obtain a high-capacity lithium ion secondary battery enhanced in safety against overcharging, a positive-electrode active material is not limited to those used in positive electrode 1 and positive electrode 2. A positive-electrode active material represented by the general formula: Li₁₊ₐNi_{b}Mn_{c}Co_{d}N′O₂ (0.05≦a≦0.1, 0.33≦b≦0.6, 0.2≦c≦0.33, 0.1≦d≦0.33, and 0≦e≦0.1) may be used. N′ represents an additive element to a positive electrode material. For example, one or plurality of elements of Al, Mg, Mo, Ti, Ge and W can be used. If such a positive-electrode active material is used, a lithium ion secondary battery having a high energy density can be obtained.

If a battery pack system is formed by using a plurality of lithium ion secondary batteries of Examples 1 to 9 mentioned above, a highly reliable power source system can be attained by taking advantage of characteristics of a highly safe single battery.

### Example 10

A battery module was prepared by using a cylindrical lithium ion secondary battery prepared in Example 1. Eight lithium ion secondary batteries were arranged in 4 rows and in two layers and electrically connected in series. An insulating spacer and a space for heat release were provided between adjacent batteries. A positive electrode terminal and a negative electrode terminal were connected in series by welding a connecting clasp between them to obtain a lithium ion secondary battery module.

### Example 11

A battery pack as a battery pack system was prepared by using the lithium ion secondary battery module prepared in Example 10. More specifically, the lithium ion secondary battery modules of Example 10 were arranged in 5 rows and in two layers and they are separately connected in series and housed in an outer case to constitute a thin battery pack. To the battery pack, a control circuit unit for monitoring and controlling a charging/discharging state and a fan for cooling were equipped. Since the battery pack is thin, it can be provided to the floor bottoms of electric cars and hybrid cars. This is suitable for keep a sufficient interior space of a car.

Other objects, features and advantages of the invention will become apparent from the following description of the embodiments of the invention taken in conjunction with the accompanying drawings.

### REFERENCE SIGNS LIST

10 . . . Positive electrode
11 . . . Separator
12 . . . Negative electrode
13 . . . Battery can
14 . . . Positive-electrode collector tab
15 . . . Negative-electrode collector tab
16 . . . Inner cover
17 . . . Inner pressure releasing valve
18 . . . Gasket
19 . . . PTC device
20 . . . Outside cover.

1. A lithium ion secondary battery comprising:
a separator,
positive and negative electrodes arranged with the separator interposed therebetween and reversibly storing/releasing lithium ions, and
an organic electrolytic solution having an electrolyte containing the lithium ions dissolved therein,
wherein the organic electrolytic solution contains an aromatic compound represented by a general formula (1) below: 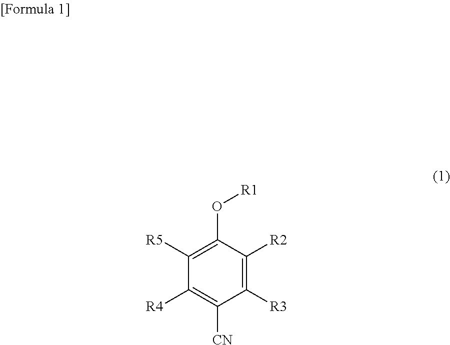
where R1 represents an alkyl group and R2 to R5 each independently represent any one of hydrogen, a halogen group, an alkyl group, an aryl group, an alkoxy group and a tertiary amine group; and
a concentration of the aromatic compound is 0.1 mol/L or less.

2. The lithium ion secondary battery according to claim 1,
wherein at least one of R2 and R5 in the general formula (1) is an electron donating group to an aromatic ring.

3. The lithium ion secondary battery according to claim 2,
wherein the aromatic compound is 3,4-dimethoxy benzonitrile.

4. The lithium ion secondary battery according to claim 1,
wherein the organic electrolytic solution contains an organic compound having a C═C unsaturated bond in the molecule.

5. The lithium ion secondary battery according to claim 4,
wherein an addition amount of the organic compound is from 0.5 to 5 wt %.

6. The lithium ion secondary battery according to claim 1,
wherein the negative electrode comprises a graphite carbon material as a negative-electrode active material;
the graphite carbon material has a graphite interlayer space d₀₀₂ within a range of 0.337 nm or more and 0.338 nm or less, and a specific surface area measured by the BET method using a nitrogen gas of 2 m²/g or less; and
the negative electrode has an irreversible capacity in a first lithium storing/releasing reaction of 45 mAh/g or more and 51 mAh/g or less in terms of weight of the graphite carbon material in the negative electrode.

7. The lithium ion secondary battery according to claim 1,
wherein the organic electrolytic solution contains an aromatic compound polymerized by electrolysis at an oxidation potential within a range of 4.3 V or more and 5.5 V or less on a lithium metal basis.

8. The lithium ion secondary battery according to claim 7,
wherein an addition amount of the aromatic compound polymerized by electrolysis within a range of 4.3 V or more and 5.5 V or less on a lithium metal basis is from 0.5 to 5 wt %.

9. The lithium ion secondary battery according to claim 1,
wherein the positive electrode comprises a positive-electrode active material represented by a general formula of Li₁₊ₐNi_{b}Mn_{c}Co_{d}N′ₑO₂, wherein N′ contains at least one of Al, Mg, Mo, Ti, Ge, and W; and 0.05≦a≦0.1, 0.33≦b≦0.6, 0.2≦c≦0.33, 0.1≦d≦0.33, and 0≦e≦0.1.

10. A battery pack system using a plurality of lithium ion secondary batteries according to claim 1.
